(19) United States
(12) Patent Application Publication
(10) Pub. No.: US 2003/0150081 A1
(43) Pub. Date: Aug. 14, 2003

(54) Protective strap for handle

(76) Inventor: Mao-Hsiu Wang, Taichung Hsien (TW)

Correspondence Address: BACON & THOMAS, PLLC, 625 SLATERS LANE, FOURTH FLOOR, ALEXANDRIA, VA, 22314

(21) Appl. No.: 10/322,528

(22) Filed: Dec. 19, 2002

(30) Foreign Application Priority Data
Dec. 31, 2001 (TW) 90224933

(51) Int. Cl. E05B 1/00

(52) U.S. Cl. 16/110.1

(57) ABSTRACT

A protective strap adapted to be wound on the handle of a sports apparatus is disclosed to include a first strap body and a second strap body. The first strap body has two long lateral sides and two short ends. One of the short ends of the first strap body is defined as a first joint end. The second strap body has two long lateral sides and two short ends. One of the short ends of the second strap body is defined as a second joint end which is connected to said first joint end of the first strap body.

### FIELD OF THE INVENTION The present invention relates generally to a protective strap, and more particularly to a protective strap for use in a handle of a sports apparatus.

### BACKGROUND OF THE INVENTION

The conventional protective strap is shaped like a long tape and is used to wind on the handle of a sports apparatus, such as golf club, racket and hockey stick, to provide the user a perfect holding feeling.

The early protective strap was made from leather, but after improvement, which is mostly replaced by synthetic material. The protective strap made of synthetic material is usually composed of a surface layer made of polyurethane (PU) by the wet PU technique, and a nonwoven fabric layer attached to the surface layer or encompassed inside the surface layer. Because the foaming nature of the surface layer, users will enjoy better shock absorption and slip-resistance feelings.

At present, manufacturers of the foaming protective strap that is made of polyurethane ceaselessly improve their productions, therefore, the efficiency derived from the application of synthetic foaming materials upon the protective strap almost exerted completely. No matter what kind of protective strap, the conventional protective strap is always constructed of a single elongated strap body and treatments of various purposes on the surface of the strap body.

However, in corresponding to the multi-sports and in order to meet the user's demand, different holding feelings must be offered on the protective strap wound on the handle of a sports apparatus. For example, when a golf club having a grip formed of the convention protective strap is held by a right-handed golfer, the grip section where is close to the club head and is held by the right hand of the golfer to control the swinging direction of the golf club suffers much of counterforce when the golf club hits the ball, thus this grip section is necessary to have a larger friction coefficient and better shock absorption effect. For the grip section where is far away from the club head and is held by the left hand of the golfer to assist the right hand and control the swinging club amplitude, this section should be in possession of small friction coefficient to prevent from excessive holding with left hand so as to interfere controlling swing direction with right hand. In the event that the striker holds the protective strap for the hockey stick occurs the same situation.

In the point that different holding feelings should be offered with a same protective strap, the conventional protective strap that comprises the single strap body is not capable of providing this effect. Although many processes applied on different parts of the single strap body of the conventional protective strap can probably offer various holding feelings on the different parts of the protective strap, the increased processing cost could be unacceptable for the manufacturers and/or the customers. Further more, the single strap body made of single material is limited for deep processing. As this result, the products with different treatment processing provide limited holding effect.

### SUMMARY OF THE INVENTION

The primary objective of the present invention is to provide a protective strap, which can provide various holding feelings on its different sections through a simple cost-saving manufacturing process.

In keeping with the principle of the present invention, the foregoing objective of the present invention is attained by the protective strap comprising a first strap body and a second strap body. The first strap body has two long lateral sides and two short ends. One of the short ends of the first strap body is defined as a first joint end. The second strap body has two long lateral sides and two short ends. One of the short ends of the second strap body is defined as a second joint end which is connected to said first joint end of the first strap body.

### BRIEF DESCRIPTION OF THE DRAWINGS

FIG. 1 is an exploded view of a first preferred embodiment of the present invention conventional protective strap wound around a handle of a sports apparatus;

FIG. 2 is a partial enlarged plane view of the first embodiment of the present invention;

FIG. 3 is a sectional view taken along line 3-3 of FIG. 2;

FIG. 4 is a schematic view showing the protective strap of the present invention wound around a hockey stick;

FIG. 5 is a partial enlarged plane view of a second preferred embodiment of the present invention.

### DETAILED DESCRIPTION OF THE INVENTION

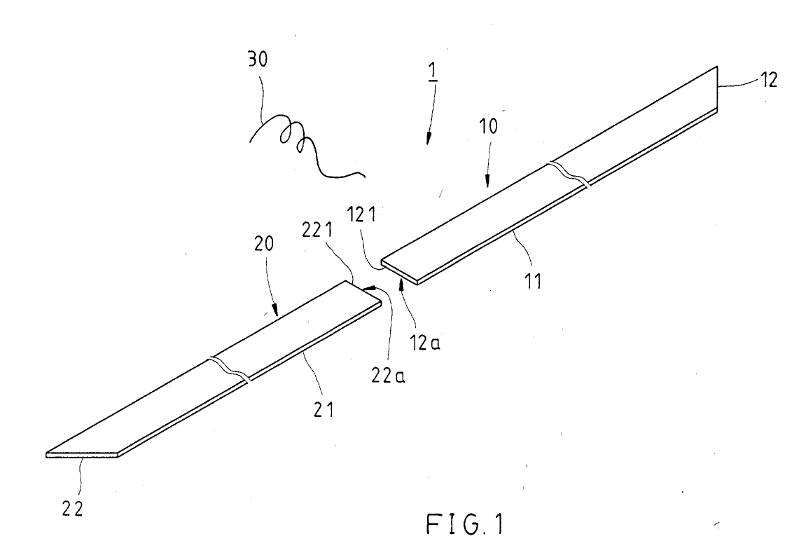

Referring to FIGS. 1-4, the protective strap 1 provided by the first preferred embodiment of the present invention is mainly composed of a first strap body 10, a second strap body 20 and a thread 30.

The first strap body 10 is shaped like a long tape and has two long lateral sides 11 and two short ends 12. One of the ends is defined as a first joint end 12a.

The second strap body 20 is also shaped like a long tape and has two long lateral sides 21 and two short ends 22. One of the ends is defined as a second joint end 22a.

The first joint end 12a of the first strap body 10 is connected to the second joint end 22a of the second strap body 20 by means of stitching the thread 30 therebetween. However, they can be connected to each other by means of any possible ways such as adhesion and/or stitching. For example, as shown in FIG. 5, the strap bodies of the protective strap are connected to each other by stitching a connecting member 70 between the strap bodies through a thread 70. In the first preferred embodiment, a first connecting face 121 is formed on the first joint end 12a. The first connecting face 121 is contacted and connected to a second connecting face 221 which is formed on the second joint end 22a by means of stitching. Accordingly the first and second strap bodies 10, 20 could join together, forming a flat protective strap 1.

The first and second connecting faces 121 and 221 can have a vertical or predetermined included angle with the top surface of the first and the second strap bodies 10 and 20. However, the connecting faces 121 and 221 are preferably in complement with each other such that the angle between the first and the second strap bodies 10 and 20 is 180° after the contact of the first and the second connecting faces 121 and 221, i.e. the two strap bodies form a smooth flat protective strap when connecting with each other.

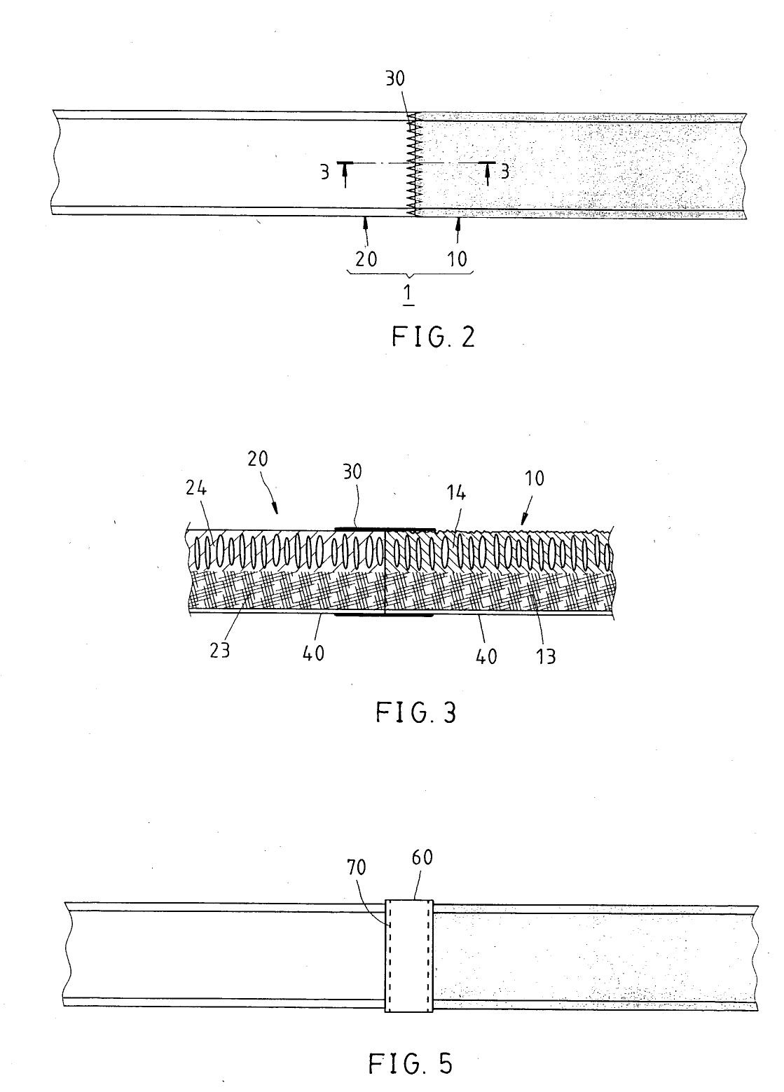

The strap bodies of the present invention can be made of different material and/or can be processed with different surface treatment such that the protective strap of the present invention can provide different surface character at two strap bodies. For example, the first strap body can be made of a synthetic material containing polyurethane by means of wet formed PU technique, and the second strap body can be made of the leather of animal. As shown in FIG. 3, in the first preferred embodiment of the present invention, the first strap body 10 has a first bottom layer 13 made of a non-woven fabric and a first top layer 14 made of polyurethane and coated on the bottom layer 13 by wet formed polyurethane technique. The second strap body has also a second bottom layer 23 made of nonwoven fabric and a second top layer 24 made of polyurethane and coated on the bottom layer 23 by wet formed PU technique. Wherein the first top layer 14 and the second top layer 24 are made of different components of the polyurethane material, and the molecule density of the second top layer 24 is a little higher than that of the first top layer 14, which makes the second top layer 24 having a larger surface friction coefficient than the first top layer 14.

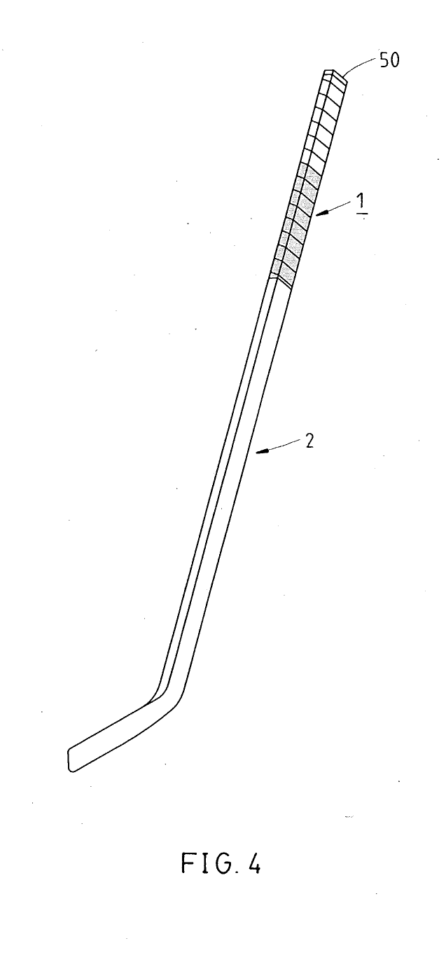

Thereby, a back-glue 40 is attached at the bottom of the first and the second bottom layers 13 and 23 of the protective strap 1. As shown in FIG. 4, when the protective strap 1 is wound around the handle of a hockey stick 2, the locations of the first and the second strap bodies 10 and 20 are respectively close to and far away from the head 50 of hockey stick 2 and are held by the left and right hands of a player respectively.

Since the top layer 24 of the second strap body 20 has a larger surface friction coefficient, a great force of friction will be generated between the surface and the player's hand, which is easy for the player to control the hockey stick 2 by his right hand. The top layer 14 of the first strap body 10 has a small surface friction coefficient, which results in a small force of friction between the surface and the player's hand. When the player holds the section wound around by the first strap body 10 on the handle, his left hand can conveniently turn around the section. It will reduce the interference on the player's right hand in controlling the hockey stick. So, the protective strap 1 will reach the purpose that different section has different holding feelings.

On the other hand, the surfaces of the top layers 14 and 24 of the first and second strap bodies 10 and 20 can be processed with different surface treatments. For example, the surfaces of the two top layers 14 and 24 will have different friction coefficients by processed with different densities and shapes of lines and corroded with chemical agents to different extent. The surface treatment can be individually processed on the strap bodies, then the cost of manufacture and processing will be efficiently reduced. It is to get different holding feelings at different sections with low cost of production.

In order to meet various requirements of other sporting tools, such as golf club and tennis racket etc., the protective strap can be constructed of two strap bodies with different materials and surface treatments.

What is claimed is:

1. A protective strap adapted to be wound on the handle of a sports apparatus, comprising:
a first strap body having two long lateral sides and two short ends, wherein one of the short ends is defined as a first joint end;
a second strap body having two long lateral sides and two short ends, wherein one of the short ends of the second strap body is defined as a second joint end which is connected to said first joint end of the first strap body.

2. The protective strap as defined in claim 1, wherein the first and second joint ends are connected with each other by mean of adhesion.

3. The protective strap as defined in claim 1, wherein the first and second joint ends are connected with each other by mean of stitching a thread therebetween.

4. The protective strap as defined in claim 1, wherein the first and second joint ends are connected with each other by mean of adhesion and stitching a thread therebetween.

5. The protective strap as defined in claim 1, wherein the first and second joint ends are connected with each other by mean of stitching a connecting member between the joint ends.

6. The protective strap as defined in claim 1, wherein the first joint end has a first connecting face and the second joint end has a second connecting face contacted with said first connecting face; the first and second joint ends are connected with each other by mean of stitching a thread therebetween.

7. The protective strap as defined in claim 1, wherein the first strap body is made of wet formed polyurethane and the second strap body is made of animal leather.

8. The protective strap as defined in claim 1, wherein the first strap body has a first bottom layer made of a nonwoven fabric and a first top layer made of wet formed polyurethane and coated on the first bottom layer; the second strap body has a second bottom layer made of a nonwoven fabric and a second top layer made of wet formed polyurethane and coated on the second bottom layer.

9. The protective strap as defined -in claim 8, wherein the first top layer and the second top layer are made of different components of polyurethane materials.

10. The protective strap as defined in claim 8, wherein the first top layer and the second top layer are made of different components of polyurethane materials and the molecular density of the second top layer is larger than that of the first top layer such that surface friction coefficient of the second top layer is higher than that of the first top layer.

11. The protective strap as defined in claim 8, wherein surfaces of the first and second strap bodies are respectively processed with different surface treatments such that the surfaces of the first and the second strap bodies have different friction coefficients.

12. The protective strap as defined in claim 1, wherein surfaces of the first and second strap bodies are respectively processed with different surface treatments such that the surfaces of the first and the second strap bodies have different friction coefficients.
